(19) United States
(12) Patent Application Publication
(10) Pub. No.: US 2024/0202266 A1
(43) Pub. Date: Jun. 20, 2024

(54) COMPUTING RESOURCE OPTIMIZATION ENGINE BASED ON CONTEXTUAL LINKAGE IN A KNOWLEDGE GRAPH

(71) Applicant: AMADEUS S.A.S., Biot (FR)

(72) Inventors: Hongliu CAO, Nice (FR); Johnny RAHAJARISON, Nice (FR)

(21) Appl. No.: 18/084,610

(22) Filed: Dec. 20, 2022

(51) Int. Cl. G06F 16/9537; G06F 16/2457; G06F 16/9535

(52) U.S. Cl. CPC G06F 16/9537; G06F 16/24578; G06F 16/9535

(57) ABSTRACT

The present specification provides, amongst other things, a novel computing resource optimization engine. In one example system, a plurality of publisher platforms for access by a plurality of client devices is provided. The plurality of publisher platforms can carry certain content for direct consumption and additional content for suggesting diversion to one of a plurality of target platforms. Each publisher platform may generate unique primary content but be configured to carry similar secondary content for the suggested diversion. The system includes an optimization engine configured to reduce wasted network bandwidth and other computing resources by biasing the diversionary content on the publisher platforms towards the client devices that more commonly result in generation of secondary content that actually causes diversions to the target platforms. The present specification can have particular application to the generation of advertising services related to activities at a travel destination.

### BACKGROUND

Communication activity on the modern Internet is distributed amongst many different server platforms offering content to millions of different client devices. Certain platforms offer similar types of content and thus compete for connections from the same client devices. Furthermore, many platforms may carry additional content intended to cause input from client devices that will divert traffic to another platform. However, the additional content may not trigger such input resulting in an overall wastage of computing resources by generating and transmitting additional content which is ignored.

### BRIEF DESCRIPTION OF THE FIGURES

FIG. 1 is a schematic diagram of a system for computing resource optimization.

FIG. 2 shows an example structure of the identifier objects of FIG. 1.

FIG. 3 is a block diagram of example internal components of the optimization engine of FIG. 1.

FIG. 4 shows a flowchart depicting a method for computing resource optimization.

FIG. 5 shows an example structure of a sub-object identifier.

FIG. 6 shows an example structure of a destination-activity dataset.

FIG. 7 shows a flowchart depicting a method for extracting contextual linkage.

FIG. 8 shows an example knowledge graph from which contextual data can be extracted.

### DETAILED DESCRIPTION

An aspect of the present specification provides a novel computing resource optimization engine. In one example system, a plurality of publisher platforms for access by a plurality of client devices is provided. The plurality of publisher platforms can carry certain content for direct consumption and additional content for suggesting diversion to one of a plurality of target platforms. Each publisher platform may generate unique primary content but be configured to carry similar secondary content for the suggested diversion. The system includes an optimization engine configured to reduce wasted network bandwidth and other computing resources by biasing the additional content on the publisher platforms towards the client devices that more commonly result in generation of secondary content that actually causes diversions to the target platforms.

An aspect of this specification provides an optimization engine server for matching and delivery of contextual data to a client device comprising a processor coupled to a memory for storing programming instructions that when executed on the processor cause the processor to:
receive a travel itinerary dataset associated with a traveler account; receive a destination activities dataset;
receive an indirect dataset associated with the traveler account;
select a subset of the destination activities dataset based on the indirect dataset;
select at least one destination activity within the subset; and,
generate an electronic message for the traveler account based on the at least one destination activity for delivery to a client device associated with the traveler account.

Methods according to the foregoing are also contemplated.

The message can be in the form of secondary content generated alongside primary content on a platform server, where the platform server was accessed by the client device in order to access the primary content. The secondary content can be for causing diversion of the client device to a target platform.

The processor can be further configured to make a selection of at least one destination activity based on a weighted relevance of each of the destination activities within the subset.

The weighted relevance can be based one or more of a duration of time and a distance travelled within the travel itinerary dataset.

The weighted relevance can also be based on one or more of season, weather, temperature associated with a location and travel dates within the travel itinerary dataset.

The weighted relevance can also be based on a proximity to a hotel identified within the travel itinerary dataset.

The weighted relevance can also be based on demographic data associated with the traveler account.

The set of destination activities can be pre-filtered according to a range of dates that correspond with the travel itinerary data.

The indirect dataset can include a list of top previously searched or booked activities during travel dates within the travel itinerary dataset.

The programming instructions can further cause the processor to receive a rating of or a confirmation of attendance at a destination activity and accordingly update the destination activities dataset.

The set of destination activities can be pre-filtered according to a range of dates that correspond with the travel itinerary data.

The delivery of the message can be responsive to a future travel inquiry.

Other aspects of the specification contemplate systems, methods and computer readable media and combinations, subsets and variations thereof, configured according to the foregoing and/or the subsequent text.

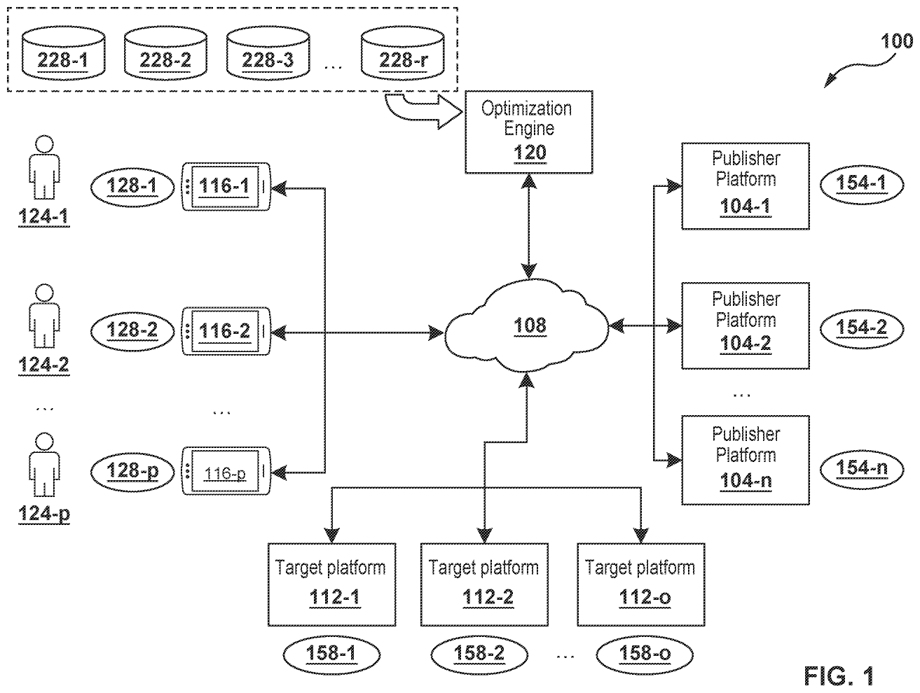

FIG. 1 shows a system for network traffic monitoring and optimization indicated generally at 100. System 100 comprises a plurality of publisher platforms 104-1, 104-2 . . . 104-n. (Collectively, platforms 104-1, 104-2 . . . 104-n are referred to as platforms 104, and generically, as platform 104. This nomenclature is used elsewhere herein.) In system 100, platforms 104 connect to a network 108 such as the Internet. Network 108 interconnects publisher platforms 104 with: a) a plurality of target platforms 112; b) a plurality of client devices 116 and, d) an optimization engine 120. As will be discussed further below, optimization engine 120 performs a number of processing functions on system 100, including hosting a plurality of databases 228.

Platforms 104 can be based on any present or future electronic media servers that publish content for client devices 116. Client devices 116 can be any type of human-machine interface for interacting with platforms 104. For example, client devices 116 can include traditional laptop computers, desktop computers, mobile phones, tablet computers and any other device that can be used to receive content via one or more of the platforms 104 that complement the input and output hardware devices associated with a given client device 116. It is contemplated client devices 116 can include virtual or augmented reality gear complementary to virtual reality or augmented reality or “metaverse” environments that can be offered on publisher platforms 104. Client devices 116 can be operated by different users 124 that are associated with a respective identifier object 128 that uniquely identifies a given user 124 accessing a given client device 116 in system 100.

In a present example embodiment, platforms 104 can be based on media platforms that carry primary content for direct consumption by users 124 at client devices 116, while also generating secondary content in the form of advertising from services. (Herein, secondary content may sometimes be referred to as diversion content or diversionary content).

To elaborate, publisher platforms 104 can be based on social media ecosystems such as Facebook, TikTok, or the like which generate their own primary content, (e.g. social media posts of users 124) and can embed their own secondary content (e.g. advertising of products or services available from target platforms 112) intended to divert a given client device 116 from the publisher platform 104 towards a specific target platform 112 that is associated with the secondary content. Publisher platforms 104 can also be based on ecosystems such as Google, that include primary content delivered via YouTube, Google Maps, Google Search, Google News, while also embedding secondary content intended to direct traffic to target platforms 112. Primary content can also be provided by publisher platforms 104 that offer web pages, social media, audio, video, movies, television, games, books, news, search results, and the like. The nature of publisher platforms 104 is thus not particularly limited. Very generally, platforms 104 carry primary content for consumption by client devices 116 and secondary content for diverting traffic to target platforms 112.

In general, secondary content is typically generated in association with the primary content and, in a present embodiment, is typically advertising. Advertising can be generated and managed by advertising services such Google Ads, or Facebook Ads, a Global Distribution System (GDS) such as Amadeus Digital Advertising, that can embed advertising content into primary content provided by other websites or apps or other primary content from platforms 104. To reiterate, secondary content is any content that, when accessed or selected on a platform 104 by a given client device 116, can cause a connection with a target platform 112.

According to a specific illustrative example, the present specification can have particular application to the travel industry and thus publisher platforms 104 can also be virtual travel agency websites including large commercial offerings such as Hotels.com, Expedia, Travelocity, virtual travel agency websites for boutique local travel agencies or the like. By the same token publisher platforms 104 may bias towards platforms that generate primary content in the form of travel blogs, travel research, travel podcasts, where secondary content for travel services may be more relevant and may be more likely to include travel advertisements that are intended to direct traffic to target platforms 112 that are travel actors and sell travel services.

Travel actors can broadly encompass different categories of all types of travel service offerings including transportation-actors; accommodation-actors and travel-destination actors. Transportation-actors can provide transportation services for users 124, such as airlines, rental car agencies, rail services, and bus lines. Accommodation-actors can provide lodging for users 124, such as hotels, resorts and B&Bs (“Bed and Breakfasts”), including the lodging at the location where a user 124 arrives after receiving a transportation service. Travel-destination actors can include providers of activities at the location where a user 124 is lodging. Travel-destination actors can thus include, by way of non-limiting examples, restaurants, spas, concert venues, exhibition centers, summits, sporting event venues, fairs, conference venues, sporting arenas, museums, art galleries, tours and resort activity centers and the like.

According to a specific illustrative example discussed further below, target platforms 112 may focus on platforms 112 hosted by travel-destination actors associated with activities that typically occur at a travel destination for a given user 124. Target platforms 112 can be based on any present or future electronic servers that publish their own content for client devices 116, and to which a diversion from a platform 104 may occur. As will be explained further below, in general, such travel-destination target platforms 112 may include an e-commerce environment including a sales workflow or interactive sales function for client devices 116, representing a customer experience sales funnel, including experiences such as service searching, service browsing, adding a service to shopping cart (often in the form of admission tickets or vouchers), checkout, and payment processing. However, in certain contexts, platforms 112 may also reference transportation-actors and accommodation-actors and their sales workflows.

Accordingly, client devices 116 are based on any suitable client computing platform operated by users 124 that may have an interest in the content being provided on platforms 104 and the services being offered on target platforms 112. Each device 116 and its user 124 is thus associated with a user identifier object 128.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects. The salient point is that they are uniquely identifiable within system 100 in association with what they represent.

Users 124 are typically individuals but may be corporate entities as well. Such users 124 interact, via devices 116, with both publisher platforms 104 as well as target platforms 112. Each consumer identifier object 128 can be used by other nodes in system 100, including publisher platforms 104, target platform 112 and optimization engine 120 to track, amongst other things: a) traffic flows between a given client device 116 and various publisher platforms 104, including interactions (impressions as well as diversions) with a given advertising campaign; b) traffic flows between a given client device 116 and target platform 112; and c) diversions of traffic originated by a given client device 116 from a given publisher platform 104 to target platform 112.

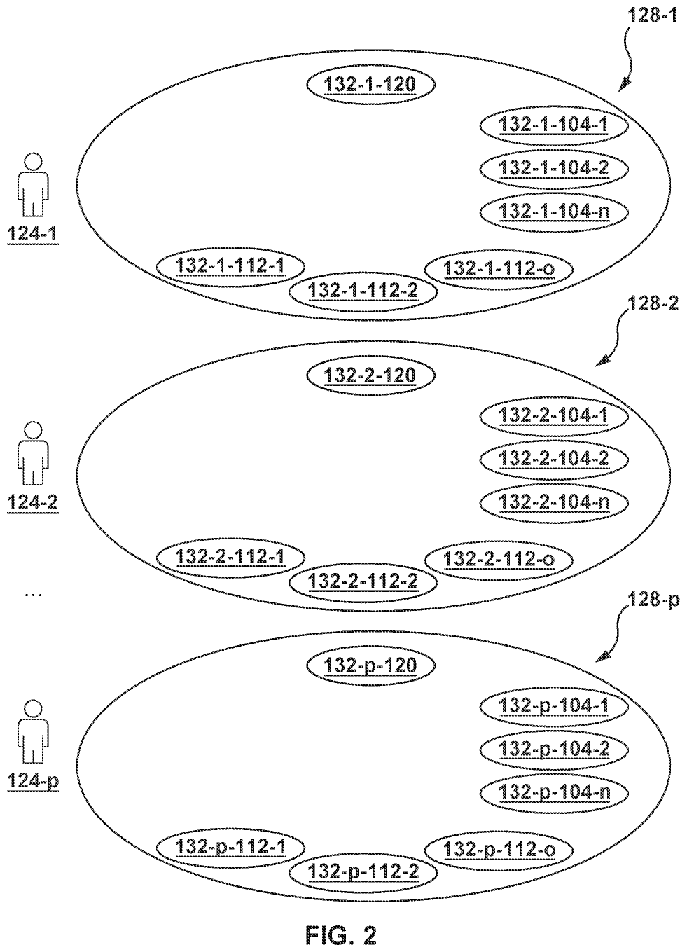

Referring now to FIG. 2, consumer identifier objects 128 can be implemented as a plurality of consumer identifier sub-objects 132. Consumer identifier sub-objects 132 follow the nomenclature 132-X-Y where X corresponds to reference for a corresponding user 124 and Y corresponds to the reference for a corresponding node in system 100. (This nomenclature builds on the earlier-discussed nomenclature, since consumer identifier objects are referred to collectively as consumer identifier objects 128 and generically as consumer identifier object 128.) To elaborate, sub-objects 132-1-Y refer to user 124-1; sub-objects 132-2-Y refer to user 124-2; sub-objects 132-p-Y refer to user 124-p. Sub-object identifier 132-1-120 refers to the identifier for user 124-1 for optimization engine 120. Sub-object identifier 132-1-104-1 refers to the identifier for user 124-1 for platform 104-1. Sub-object identifier 132-1-104-2 refers to the identifier for user 124-1 for platform 104-2. This nomenclature repeats for all identifier sub-objects 132 for each user 124, across each publisher platform 104 and each target platform 112.

Sub-objects 132 may be provided to anonymize, for privacy purposes, the specific identity (i.e. personally identifying information or PII) of the associated user 124. Some or all of those identifier sub-objects 132 may be anonymous or private to certain nodes in system 100 while being non-private to other nodes. For example, the operator of a target platform 112 may maintain an account (a form of consumer identifier sub-object 132-X-112) respective to each user 124-X that expressly identifies the user 124-X to handle delivery and payment processing of a given purchased good or service, such as a ticket or voucher for a service at a travel destination. At the same time, the operator of publisher platform 104 need not expressly identify a given user 124 in order to fulfill its advertising campaign functions, but can instead rely upon, (via “cookies”, type of identifier sub-object 132-X-104, or the like), generic demographic information respective to the user 124-X that can be configured to permit targeting of an advertising campaign to a client device 116 while respecting the individual anonymity of the user 124-X of the client device 116. Accordingly, in certain embodiments, it is contemplated that a consumer identifier sub-object 132 may comprise a cookie that is used by a publisher platform 104, whereas another consumer identifier sub-object 132 may comprise the account information of the user 124 as used by target platform 112. However, for simplification of explanation of the present embodiment, a single consumer identifier object 128 for each user 124 may be referenced in this specification, but a person skilled in the art will now appreciate such simplification and that contextually, a reference to an identifier object 128 for a given node in system 100 may involve the use of a consumer identifier sub-object 132 instead. By the same token, it is this contextual complexity that reveals one of the technical advantages of the present specification, which will become apparent with further reading, in that the disparate and often anonymous nature of identifier sub-objects 132 make load balancing of system 100 difficult, a difficulty that is mitigated by the present specification.

Referring again to FIG. 1, persons skilled in the art will recognize that there are many different types of interactions between client devices 116 accessing platforms 104, and that there are also many different ways such interactions may lead to diversions that cause a given client device 116 to access target platform 112. For example, it is possible that there will be repeated diversions from the same or different platforms 104 during different stages in a sales funnel experience of target platform 112. For example, client device 116-1 may access platform 104-1 and be exposed to an advertisement connected to an advertising campaign that causes client device 116-1 to direct traffic to an “offer for sale” web page on platform 112-1 that is offering a service. As part of the sales funnel experience, the client device 116-1 may send input that “adds” that product to a virtual “shopping cart” on target platform 112-1, but client device 116-1 may not, during the same session, send input that completes the “checkout” portion of the sales funnel experience. This incomplete sales funnel experience can then be logged within system 100 such that, during a subsequent access from client device 116-1 to platform 104-1, there may be exposure to another advertisement also based on the advertising campaign, that causes traffic from client device 116-1 to be directed to a “checkout” web page on target platform 112-1, urging completion of the “checkout” or purchasing portion of the sales funnel experience. To reiterate, this is but one example and with the benefit of further study of this specification a person of skill in the art will appreciate how the present teachings can be applied to these different types of interactions between client devices 116, publisher platforms 104 and the sales funnel experience on target platform 112.

It is contemplated that each publisher platform 104 has a publisher-reporting application 154 stored in non-volatile storage of the respective platform 104 and executable on its processor. The publisher-reporting application 154 can be accessed by optimization engine 120 to track the number of impressions and/or diversions (if any) from the respective publisher platform 104 to target platform 112 that are associated with each consumer identifier object 128. The publisher-reporting application 154 can also be used to track queries or search for a given identifier 128 (or a given sub-object identifier 132-X-104) or the types of primary content being accessed on the platform 104. For example, repeated searches for a travel destination for an activity at a travel destination may be recorded in application 154 for later access by optimization engine 120.

It is contemplated that target platforms 112 also include a target-reporting application 158 stored in non-volatile storage and executable on their processors. The target-reporting application 158 can be used by each administrator 128 to track the various stages of the sales funnel experience for a user 124 via their respective identifier object 128. Target-reporting applications 158 can also maintain historical and future travel itineraries for each identifier 128.

Optimization engine 120 can also be configured to obtain reports based on: a) the reports from each publisher-reporting application 154; in combination with b) reports from target-reporting application 158. Such reports thereby simplify the process of comparing the relative progress through the sales funnel experience, including actual sales conversions, associated with a given advertising campaign on each publisher platform 104 for a respective product. In turn, the normalized reports can be used to adjust advertising campaigns and/or control which platform servers 104 are provided with advertising campaigns, thereby reducing or eliminating wasted delivery (and associated waste of communication and other computing resources) of advertising campaigns from publisher platforms 104 that do not result in diversions to target platform 112.

Optimization engine 120 can also be configured to access publisher-reporting applications 154 to note, in the aggregate, top searches for destination activities by users 124 while preserving anonymity of those users 124.

Optimization engine 120 can also be configured to access target-reporting applications 158 to obtain travel itineraries for different users 124. If permission is granted by a user 124 then optimization engine 120 may specifically identify a given user 124; or if no permission is granted, then optimization engine 120 may only access meta-results such as top destination activities that are actually booked for a given target platform 112.

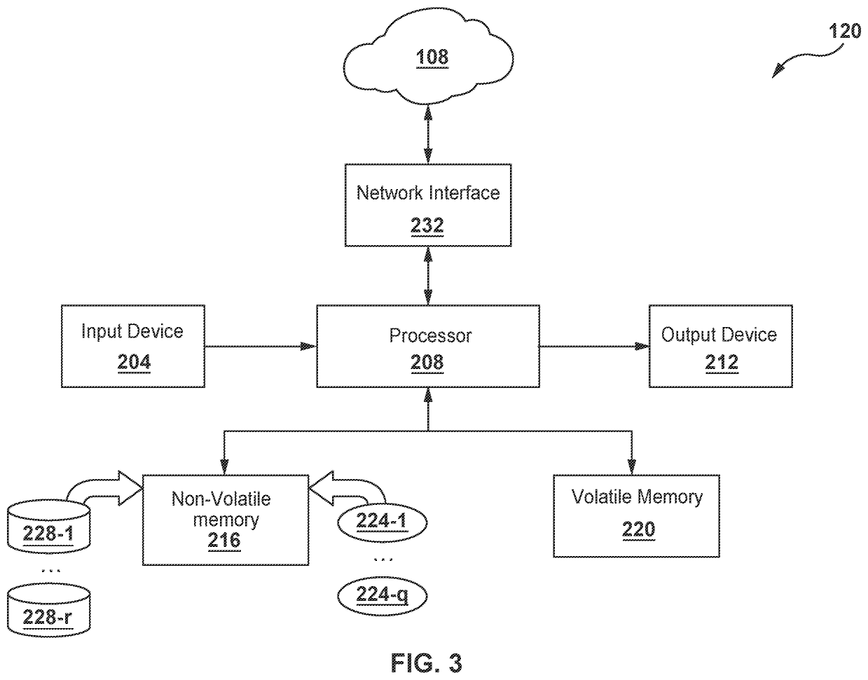

Having described an overview of system 100, it is useful to comment on the hardware infrastructure of system 100. FIG. 3 shows a schematic diagram of a non-limiting example of internal components of optimization engine 120.

In this example, optimization engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of optimization engine 120, or a variant thereon, can be used to implement any of the computing nodes in system 100, including platforms 104 and target platform 112. Furthermore, optimization engine 120, platforms 104 and target platform 112 may also be implemented as virtual machines and/or with mirror images to provide load balancing.

Furthermore, a person of skill in the art will recognize that the core elements of processor 208, input device 204, output device 212, non-volatile memory 216, volatile memory 220 and network interface 232, as described in relation to the server environment of optimization engine 120, have analogues in the different form factors of client machines such as those that can be used to implement client devices 116. Again, client devices 116 can be based on computer workstations, laptop computers, tablet computers, mobile telephony devices or the like.

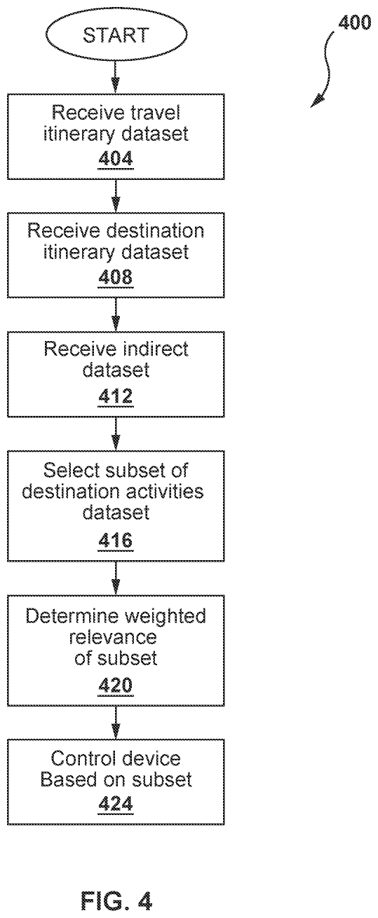

FIG. 4 shows a flowchart depicting a method for network traffic monitoring and optimization indicated generally at 400. Method 400 can be implemented on system 100. Persons skilled in the art may choose to implement method 400 on system 100 or variants thereon, or with certain blocks omitted, performed in parallel or in a different order than shown. Method 400 can thus also be varied. However, for purposes of explanation, method 400 will be described in relation to its performance on system 100 with a specific focus on treating method 400 as application 224-1 maintained within optimization engine 120 and its interactions with the other nodes in system 100.

In general, method 400 configures the processor in optimization engine to assess a booked travel itinerary associated with a given identifier 128 and to select and optionally generate secondary content on one or more publisher platforms 104 accessible from a client machine 116 associated with the identifier 128 and to generate secondary content that has a greater likelihood of causing a diversion to a target platform 112 than if the secondary content was generated without the use of method 400. Method 400 refers to a single identifier 128, but it is to be understood that method 400 can be massively scaled to handle a plurality of identifiers 128 (and/or implementing sub-object identifiers 132 as desired) associated with a plurality of different users 124, client devices 116, publisher platforms 104 and target platforms 112.

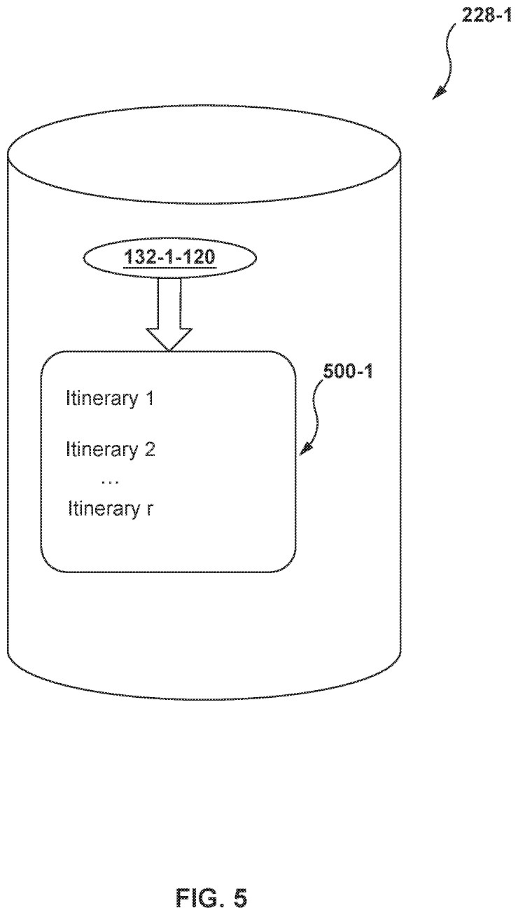

Block 404 comprises receiving a travel itinerary dataset. In system 100, a travel itinerary dataset 500 is received at processor 208 of optimization engine 120. In general terms, the travel itinerary dataset is received in association with an account for user who can be a potential traveler and therefore a consumer of travel services offered by target platform 112. Such an account can be associated with a respective identifier 128 or sub-object identifier 132. FIG. 5 provides an illustrative example of such a travel itinerary dataset 500-1 for user 124-1, which is stored in database 228-1 for access by processor 208 in association with sub-object identifier 132-1-120. Continuing with this example, travel itinerary database 228-1 includes enriched global distribution system (GDS) data of prior travel itineraries associated with sub-object identifier 132-1-120. Each itinerary includes historical transportation-actor information such as origin and destination information for transportation taken by user 124-1, carrier, dates, seating class and/or ticket pricing. Each itinerary may include historical accommodation information, such as hotel name, check-in/check-out dates, and accommodation type at the destination based on accommodation-actor information. Each itinerary may include destination-activity information from travel-destination actors, although this information is not necessary. (However, with the benefit of this specification, it is contemplated that travel-destination information can become more readily available for each user 124.) Each itinerary may also include information linking the itineraries of other identifiers 128-2 . . . 128-p of other users 124-2 . . . 124-p, who may have also accompanied user 124-1. For example, such linking information may include a common passenger name record (PNR) for a given itinerary for different identifiers 128.

At this point it can be noted that method 400 can be applied to prospective travel where an itinerary within dataset 500-1 may refer to future travel with a transportation-actor, where passage has already been booked, but few or no services from accommodation services from accommodation-actors have been engaged, and/or few or no activities with travel-destination actors have been engaged. Alternatively, method 400 can be applied to prospective travel where no transportation-actor has been engaged to book passage for user 124-1 whatsoever. As will become more apparent, method 400 has general application to directing traffic to target platforms 112 during any point of a selection and booking a complete travel experience, from the selection and booking of transportation, to the selection and booking of accommodation and to the selection and booking of destination activities.

(Note while the present exemplary embodiment focuses on prospective travel, in variants, method 400 can be also applied to building and augmenting a purely historical travel profile of historical data, such as the historical portion of dataset 500 itself, for a given user 124 without necessarily any potential for prospective future travel. Such an historical profile can be used in for a variety of purposes including, but not limited to, further iterations of method 400 for subsequent prospective travel. However, for simplified illustrative purposes the following discussion focuses on the prospective travel example.)

As noted, dataset 500 can originate from a GDS such as Amadeus, Sabre, Galileo, Worldspan, Apollo, or Pegasus. Dataset 500 can also originate from the records of one or more individual travel-actors operating different target platforms 112. Where appropriate authorizations are provided from user 124, then dataset 500 can be an aggregation of different travel itinerary datasets from different sources, including travel itinerary datasets associated with different target-reporting applications 158 respective to the target platforms 112 operated by various travel actors. Recall, such target-reporting applications 158 can maintain their own travel itinerary datasets associated with identifier 128-1 or via a unique respective sub-object identifier 132-1-112.

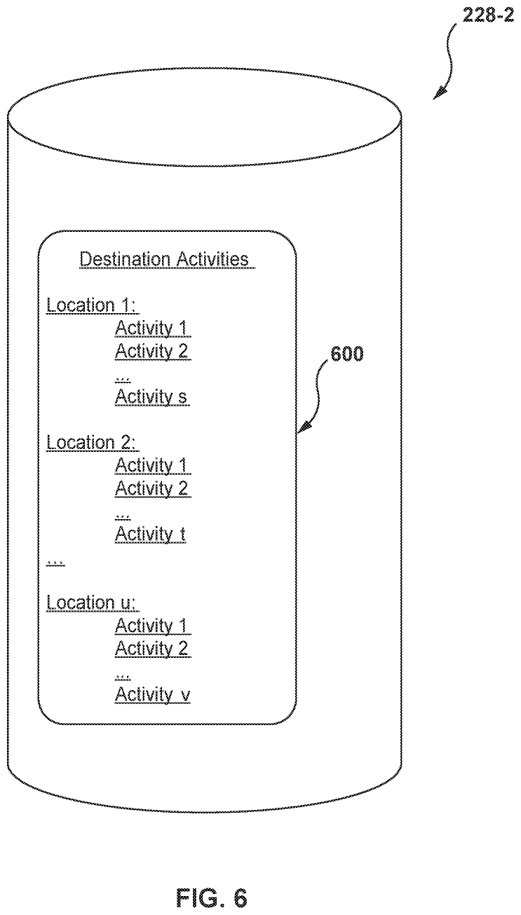

Referring again to FIG. 4, block 408 comprises receiving a destination activities dataset. In system 100, a destination-activity dataset 600 is received at processor 208 of optimization engine 120. FIG. 6 provides an illustrative example of such destination-activity dataset 600, which is stored in database 228-2 for access by processor 208. Destination-activity dataset 600 includes a list of geographic locations and a list of activities at those destinations. Each destination is associated with a date range, a description and an activity-classification. Other information can be included such as pricing and/or ticket or voucher availability. Recall, destination activities may include, by way of non-limiting examples, restaurant meals, spas, concerts, exhibitions, summits, sporting events, fairs, conferences, museums, art galleries, tours and resort activities. Given the large of number of locations on planet Earth and its population, a person of skill in the art will appreciate that dataset 600 can be absolutely massive (and likely incomplete) in terms of every single destination activity occurring on Earth. Dataset 600 is dynamic and constantly updated, and may be implemented as a query engine of other nodes on network 108 rather than a set of data stored in optimization engine 120. Dynamic queries to implement dataset 600 can be implemented by queries for destination activities on those target platforms 112 that are respective to destination-activity actors, which can be accessed in real-time for a given destination location. Alternatively, destination-activities for a given target platform 112 can be periodically pushed into dataset 600 from each target platform 112 and stored in database 228-2.

Referring again to FIG. 4, block 412 comprises receiving an indirect dataset. Examples sources of indirect data include reporting applications 154 for the top searched and/or booked activities during various ranges of travel dates, as collected by a search engine or the like operating a platform 104. Another example of indirect data includes reporting applications 158 based on an aggregation of top-booked destination activities from destination-activity actors operating different platforms 112. Other indirect data sources include the online reviews and tourism office data. The indirect dataset mitigates issues of data privacy violations for individual users 124.

Block 416 comprises selecting a subset of the destination activities dataset from block 408 based on the indirect dataset from block 412. In general terms, the indirect dataset corresponds to the account for the user 124 from block 404. (Such an account being associated with a respective identifier 128 or sub-object identifier 132 of the relevant user 124.) The primary criteria filters for block 416 include a location of a travel destination and dates of travel for the traveler account. In a present embodiment, assume that travel itinerary dataset 500-1 includes a future-travel booking including booked passage with a travel-actor. The booked passage in dataset 500-1 will thus include a travel destination and dates of departure and return. Accordingly, the destination and dates of travel associated with that booked passage can provide the primary criteria filters for block 416.

With the destination and dates known for user 124-1, the destination activities from dataset 408 can be cross referenced using the top searched and/or booked activities from block 412. In this fashion the full range of destination activities from block 408 can be filtered down to a list of potentially relevant activities for the user 124-1.

At this point, platforms 104 can be controlled to generate secondary content for client device 116-1 as it is being operated by user 124-1 to show a full list of potentially relevant destination-activities. However, it is presently preferred to also follow the optional block 420, which comprises determining a weighted relevance of the subset from block 416.

The weighting can be based on one or more factors, such as contextual factors for the itinerary, including, for example: Seasonality, weather, temperature, etc.; hotel proximity (near hotel activities); Traveler information: age, number of travelers in the group and/or demographics of the travelers in the group; trip duration and trip distance.

Block 424 comprises controlling a device or platform in system 100 based on the subset, or a selection from the subset. For example, block 424 can comprise controlling various platforms 104 to, for example, generate secondary content that includes advertising based on the results of block 420. The secondary content is directed at client devices 116 being operated by users 124 mostly likely to cause the user 124 to divert traffic from the relevant platform 104 to the target platform 112. Block 424 can also include other types of controlling, such as the generation of messages that are used to build historical travel itineraries such as dataset 500, that itself can be used for a variety of purposes including, but not limited to, future use at block 404.

As noted, method 400 can apply to all stages of booking of travel. For example, initially, destination activities for a plurality of locations may be shown, but once more trip data is gathered, such as exact flights, hotel bookings and the like, then the activity data can be refined. Explicit user interests can be extracted with a corresponding score. For example. based on what activities are in common based on previous trips and their weights. The weight refinement can be performed using any desired weighting technique, such as:
1) Search dataset 500 or other sources of historical itineraries for common travel interests, with the assumption that traveler has some consistent travel interests. For example, weightings of preferences can be derived from past trips, and accordingly the average weighting of traveler interest from each trip can be abstracted to a generalized traveler interest. The weights of each trip can be updated correspondingly.
2) For traveler's future trip, destination activities can be recommended (by email, push up notifications, etc.) based on the top interests that were “guessed” and then, based on, user feedback (clicks), the weights of each user interest can be updated.

Interest scores for various users 124 can be collected and derived from reporting applications 154 and/or reporting applications 158 to further refine future delivery of secondary content directed towards curated lists of destination activity from block 416 and/or block 420 during subsequent cycles through method 400 for a given user 124.

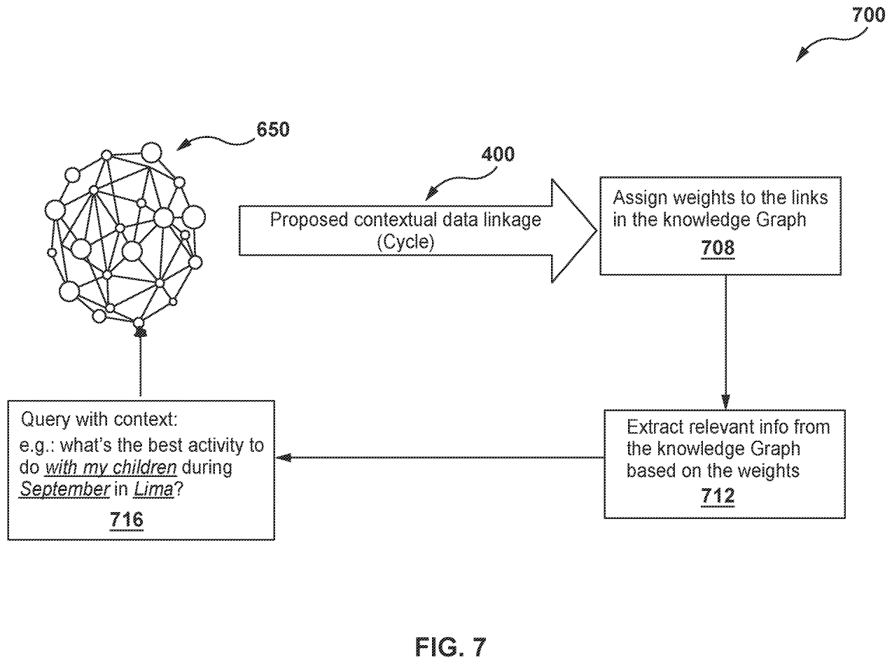

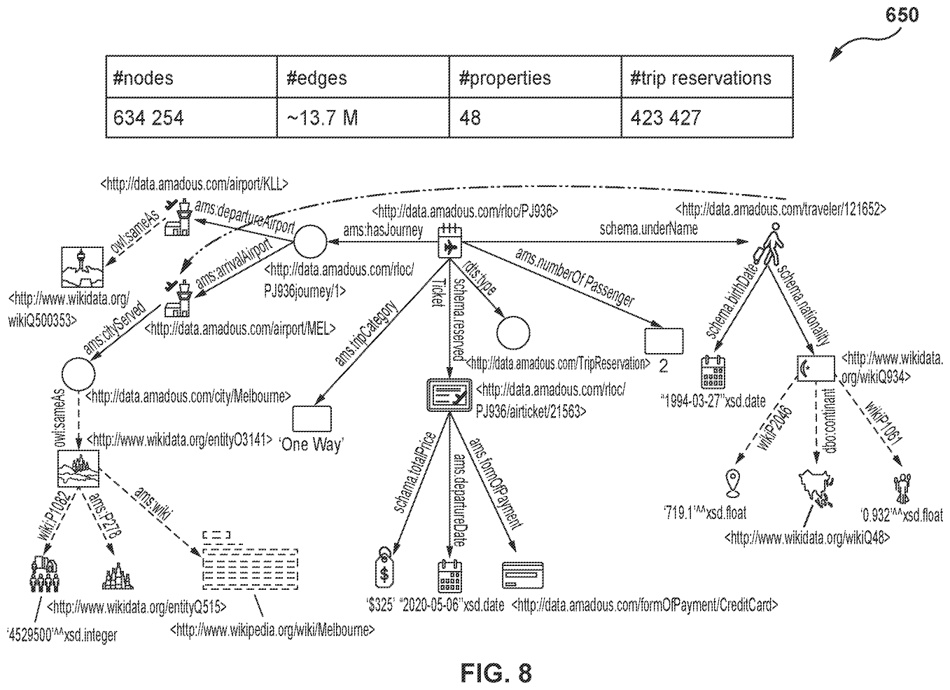

FIG. 7 shows a method 700 for extracting contextual linkage from a knowledge graph 650 in accordance with another embodiment. Knowledge graph 650 can be based on Dadoun, A.; Troncy, R.; Defoin-Platel, M.; Solano, G. A.. “Predicting your next trip: A knowledge graph-based multi-task learning approach for travel destination recommendation” 2021 Workshop on Recommenders in Tourism, RecTour 2021; 2974:23-38, 2021, the contents of which are incorporated herein by reference. Knowledge graph 650 can be based on different approaches, and deal with the incomplete information (the missing traveler's activities data) by adding publicly available information to the destination city (e.g., adding Wikipedia description of a city). An example of knowledge graph 650 is shown in FIG. 8. The problem with such solutions is the overly-connected knowledge graph 650 results in an information explosion with irrelevant information to the trip/traveler, as in the problem of the uncurated information from block 408, leading to excessive use of computing resources in system 100.

A knowledge graph 650 that assigns all possible activities in a destination to a trip can result in building hundreds of irrelevant links, as shown in example of FIG. 8. With method 400, the links to a trip are reduced to tens with a relevance score for each link based on the travel context information, from the massive number of nodes and edges within the original graph.

Returning to FIG. 7, method 700 shows knowledge graph 650 being provided as input to method 400, with portions of the graph satisfying at least one of block 408, block 412, and/or block 416. Block 708 comprises assigning weights to the links in the knowledge graph 650, while block 712 comprises extracting relevant information from the knowledge graph 650 based on block 708. Block 708 and block 712 can thus be analogized to block 420 and block 424 from method 400, except as applying method 400 to a knowledge graph.

Block 716 comprises providing a contextualized query to knowledge graph 650. The contextualized query can thus, in substance, include timing and location as well as some specific context that may be desired, such as the inclusion of who will be travelling companions, as in “What is the best activity to do with my children during September in Lima”, leading to a curation of child-friendly activities in Lima Peru during the month of September. Other specific contexts may include whether the activity is artistic, intellectual, athletic, outdoors, indoors, etc.

To elaborate, FIG. 7 illustrates how a general knowledge graph such as graph 650 can benefit from method 400 to be able to answer contextual questions that the knowledge graph 650 cannot normally answer without method 400. Block 716 shows an example query with multiple contextual information to the general knowledge graph 650. A general knowledge graph such as knowledge graph 650 cannot, on its own, answer the question taking into account all the contextual information. With method 400, different weights based on the contextual information can be assigned to the links in the knowledge graph. The assigned links with weights are stored at block 708. Then, at block 712, the nodes with top weighted links are selected to provide a response to the query at block 716.

It is also contemplated that one or more machine learning functions can be implemented herein. As one example, the sources of the destination activities dataset from block 408 can be refined based on those filtering that occurs at block 412, block 416 and block 420, to reduce the massive volume of data that is potentially available at block 408. As another example, the most relevant indirect dataset results for block 412 can be curated manually, and then captured in a neural network learning exercise such that the top results can be automatically selected and/or adjusted based on the output of such a neural network. As another example, the weighted relevance from block 420 can be compared against actual diversions to target platforms 112, and the weighting systems can be continually updated using a neural network. Method 700 is also amenable to machine learning, with block 716 helping to continually refine which portions of knowledge graph 650 are the most relevant.

The one or more neural networks may include machine-learning algorithms and/or deep learning algorithms but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. To be clear, any suitable machine-learning algorithm and/or deep learning algorithm and/or neural network is within the scope of present specification.

In view of the above it will now be apparent that variants, combinations, and subsets of the foregoing embodiments are contemplated. For example, in a variant embodiment, where travel itinerary dataset 500-1 does not include any future booked passage with a travel-actor, then the destination and dates of travel for block 416 can be derived from via reporting applications 154, based on prior activities on platforms 104, such as searching and/or browsing history of the associated identifier 128-1. Where user 124-1 authorizes actual identification of user 124-1, then the primary criteria filters for block 416 can be based on actual searching and/or browsing history of user 124-1. Where user 124-1 prefers to remain anonymous, then the primary criteria filters for block 412 can be based on searching and/or browsing patterns for users 124 who are demographically similar to user 124-1. According to this variant, system 100 can be used to generate secondary content for a complete travel experience for a given user 124, including travel, accommodation, and destination activities. In other words, the generation of relevant secondary content for a user 124 of a destination activity that the user 124 was otherwise unaware of can spur the booking of a complete travel itinerary. To give a specific example, assume that user 124-1 has travelled to New York from Tokyo on several previous occasions as per travel itinerary dataset 500. Also assume also that user 124-1 falls into a demographic of fan of a particular recording artist that happens to be performing in New York. Accordingly, according to method 400, user 124-1 can be presented with secondary content for that recording artist and thus spur a complete travel booking of flights, accommodation, and concert tickets for that artist.

As another example variation, as discussed earlier the nature of how a device is controlled at block 424 is not particularly limited. In one variation of block 424, the results from block 420 can be made the response message generated on a client device 116 where the query is, in substance, “Identify relevant destination activities for me at location X”. As another example, a screen saver showing a destination activity from block 424 can be pushed to the display of a client device 116 when the device 116 has been inactive or has a “screen lock”. As another example, block 424 can be part of an interactive automated chatbot service to help user 124 book a destination activity. Other examples can include controlling a device to perform user segmentation, user profile creation or any other applications that need explicit travel/user interest. Many different types of electronic messages can thus be generated at block 424. The results from block 420 can thus be used in a myriad of ways to control various devices in system 100 and other devices that connect to network 108 that are not shown.

As another example variation, the foregoing has been discussed in relation to travel services, but it is also contemplated that other types of e-commerce products and services can benefit from the teaching herein.

A person skilled in the art will now appreciate that the teachings herein can improve the technological efficiency and computational and communication resource utilization across system 100 by limiting the dissemination of advertising to those publisher platforms 104 that have the greater number of diversions to target platforms 112 thereby making more efficient use of network and processing resources in system 100. Given the size of dataset 600, and/or knowledge graph 650, without the present teachings a person of skill in the art will appreciate that prior art generation of secondary content in the form of advertising of destination activities on random client devices 124 without curation can lead to a significant wastage of computing and network resources in system 100. In other words, failure to generate relevant secondary content on platforms 104 that do not lead to diversions to target platforms 112 may lead to wasted generation of secondary content on client devices 116, with attendant waste of network bandwidth on network 108 and processing resources on client devices 116. Furthermore, a failure to generate traffic on target platforms 112 can lead to underutilized processing resources on target platforms 112. Thus, overall load balancing in system 100 is better achieved when traffic is diverted, on a reasonably consistent basis, from publisher platforms 104 to target platforms 112. The present teachings also tackle the problem of generating such advertising in contexts that lack specific identification of the identity (often called personally identifiably information or PII) of a given user 124. Restricting the availability of PII on system 100 further restricts the ability for target platforms 112 and/or published platforms 104 to generate relevant secondary content on platforms 104 further disrupting the load balancing of system 100, and the present teachings help mitigate that technical limitation. Thus, various ways of improving load balancing across system 100 are disclosed herein.

It should be recognized that features and aspects of the various examples provided above can be combined into further examples that also fall within the scope of the present disclosure. In addition, the figures are not to scale and may have size and shape exaggerated for illustrative purposes.

1. A server for matching and delivery of contextual data to a client device comprising:
a processor coupled to a memory for storing programming instructions that when executed on said processor cause said processor to:
receive a travel itinerary dataset associated with a traveler account;
receive a destination activities dataset;
receive an indirect dataset associated with said traveler account;
select a subset of said destination activities dataset based on said indirect dataset;
select at least one destination activity within said subset; and,
generate an electronic message for said traveler account based on said at least one destination activity for delivery to a client device associated with said traveler account.

2. The server of claim 1 wherein said message is in the form of secondary content generated alongside primary content on a platform server; the platform server having been accessed by the client device in order to access the primary content; the secondary content for causing diversion of the client device to a target platform.

3. The server of claim 1 wherein the processor is further configured to make a selection of at least one destination activity based on a weighted relevance of each of said destination activities within said subset.

4. The server of claim 3 wherein said weighting relevance is based one or more of a duration of time and a distance travelled within said travel itinerary dataset.

5. The server of claim 3 wherein said weighting relevance is based on one or more of season, weather, temperature associated with a location and travel dates within said travel itinerary dataset.

6. The server of claim 3 wherein said weighting relevance is based on a proximity to a hotel identified within said travel itinerary dataset.

7. The server of claim 3 wherein said weighting relevance is based on demographic data associated with said traveler account.

8. The server of claim 1 wherein said set of destination activities is pre-filtered according to a range of dates that correspond with said travel itinerary data.

9. The server of claim 1 wherein said indirect dataset includes a list of top previously searched or booked activities during travel dates within said travel itinerary dataset.

10. The server of claim 1 wherein said programming instructions further cause said processor to receive a rating of or a confirmation of attendance at a destination activity and accordingly update said destination activities dataset.

11. The server of claim 1 wherein said set of destination activities is pre-filtered according to a range of dates that correspond with said travel itinerary data.

12. The server of claim 1 wherein said delivery is responsive to a future travel inquiry.

13. A server for matching and delivery of contextual data to a client device comprising:
a processor coupled to a memory for storing programming instructions that when executed on said processor cause said processor to:
receive a travel itinerary dataset associated with a traveler account;
arrange, in the memory, said travel itinerary dataset according to a knowledge graph;
receive a destination activities dataset corresponding to said travel itinerary dataset;
match a subset of said destination activities dataset with an indirect dataset associated with said travel itinerary dataset;
determining, target nodes on said knowledge graph that correspond to said subset of said destination activities dataset;
arrange, in said memory, said subset of said destination activities dataset according to said target nodes;
determine a weighting for each target node within said subset of said destination activities dataset representing a relevance of a destination activity with said traveler account;
store, in said memory, each said weighting at a respective target node;
select, according to said weightings, at least one of said destination activities at its respective target node; and,
generate a message for said traveler account based on a selected target node for delivery to a client device associated with said traveler account.
